(19) United States
(12) Patent Application Publication
(10) Pub. No.: US 2014/0129202 A1
(43) Pub. Date: May 8, 2014

(54) PRE-SIMULATION CIRCUIT PARTITIONING

(71) Applicant: INTERNATIONAL BUSINESS MACHINES CORPORATION, Armonk, NY (US)

(72) Inventors: Ali Sadigh, Irvine, CA (US); David W. Winston, Asheville, NC (US)

(73) Assignee: INTERNATIONAL BUSINESS MACHINES CORPORATION, Armonk, NY (US)

(21) Appl. No.: 13/670,960

(22) Filed: Nov. 7, 2012

(51) Int. Cl. G06F 17/00

(52) U.S. Cl. CPC G06F 17/00
USPC 703/14

(57) ABSTRACT

Before supplying a series of instructions to a circuit simulator, methods and systems cache the series of instructions and partition the series of instructions into an active portion and an inactive portion. Instead of supplying the entire series of instructions to the circuit simulator, the methods and systems supply only the instructions directed to the active portion of the integrated circuit to the circuit simulator. Thus, the circuit simulator creates a reduced circuit simulation from just the instructions directed to the active portion (instead of a full integrated circuit that would have been simulated with the entire series of instructions). The reduced circuit simulated by these systems and methods has less circuit elements relative to any integrated circuit that would have been simulated with the entire series of instructions. Thus, this reduced circuit is only a portion of the integrated circuit that would have been simulated.

### BACKGROUND

The present disclosure relates to integrated circuit simulation, and more specifically, to performing circuit partitioning before performing circuit simulation.

One issue associated with integrated circuit simulation is the issue of how to reduce circuit simulation overhead in large circuits that have a small active partition. Advances in device evaluation and simulation techniques have exposed circuit setup and memory management overhead as performance bottlenecks. The processor time for circuit simulation dominates transistor-based analysis (i.e., static timing analysis, characterization) because there are a large number of channel-connected components (CCC) creation/deletion steps, there are very complex models, sophisticated device physics are prevalent, there are many parasitics or interconnects requiring more processing time.

### SUMMARY

An exemplary method herein receives a series of instructions directed to a circuit simulator (such as application program interface (API) calls or netlist parsing calls) into a computerized device. The circuit simulator uses the series of instructions to create a simulation of an integrated circuit. The series of instructions can include circuit element description, electrical connections, and node identifications, etc.

However, before supplying the series of instructions to the circuit simulator, the methods and systems herein partition the series of instructions into instructions directed to an active portion of the integrated circuit and instructions directed to an inactive portion of the integrated circuit, using the computerized device. The partitioning process can be, for example, based on a previously determined combination of enabled and disabled transistors that indicate what parts of the simulated circuit would be active and which would be inactive.

Then, instead of supplying the entire series of instructions to the circuit simulator, the methods and systems herein supply only the instructions directed to the active portion of the integrated circuit to the circuit simulator, using the computerized device. Thus, the circuit simulator creates a simulation of a reduced circuit from just the instructions directed to the active portion of the integrated circuit (instead of a full integrated circuit that would have been simulated with the entire series of instructions). The circuit simulator can perform, for example, an application program interface (API) based simulation and a netlist-driven simulation, etc.

The reduced circuit simulated by these systems and methods has less circuit elements relative to any integrated circuit that would have been simulated with the entire series of instructions. Thus, this reduced circuit is only a portion of (the active portion) and is less than all of the integrated circuit that would have been simulated with the entire series of instructions.

Another method herein receives a series of instructions directed to a circuit simulator (such as API calls or netlist parsing calls) into a computerized device. Again, the circuit simulator uses the series of instructions to create a simulation of an integrated circuit. In this method, before supplying the series of instructions to the circuit simulator, the methods and systems herein cache the series of instructions in a cache memory of the computerized device. Then, after the series of instructions have been cached (but still before supplying the series of instructions to the circuit simulator) the methods and systems herein partition the series of instructions into instructions directed to an active portion of the integrated circuit and instructions directed to an inactive portion of the integrated circuit, using the computerized device. The partitioning process occurs after all the series of instructions have been cached and the partitioning can be, for example, based on a previously determined combination of enabled and disabled transistors that indicate what parts of the simulated circuit would be active and which would be inactive.

Then, instead of supplying the entire series of instructions to the circuit simulator, the methods and systems herein again supply only the instructions directed to the active portion of the integrated circuit to the circuit simulator, using the computerized device. Thus, the circuit simulator creates a simulation of a reduced circuit from just the instructions directed to the active portion of the integrated circuit (instead of a full integrated circuit that would have been simulated with the entire series of instructions). The reduced circuit simulated by these systems and methods has less circuit elements relative to any integrated circuit that would have been simulated with the entire series of instructions. Thus, this reduced circuit is only a portion of (the active portion) and is less than all of the integrated circuit that would have been simulated with the entire series of instructions, and this partitioning is done without incurring the unnecessary overhead that would be experienced conventionally.

### BRIEF DESCRIPTION OF THE DRAWINGS

The embodiments herein will be better understood from the following detailed description with reference to the drawings, which are not necessarily drawing to scale and in which:

FIG. 1 is a flow diagram illustrating embodiments herein;

FIG. 2 is a flow diagram illustrating embodiments herein;

FIG. 3 is a schematic diagram of a hardware system according to embodiments herein;

FIG. 4 is a schematic diagram of a deployment system according to embodiments herein;

FIG. 5 is a schematic diagram of an integration system according to embodiments herein;

FIG. 6 is a schematic diagram of an on demand system according to embodiments herein;

FIG. 7 is a schematic diagram of a virtual private network system according to embodiments herein; and

FIG. 8 is a schematic diagram of a virtual private network system according to embodiments herein.

### DETAILED DESCRIPTION

As mentioned above, device evaluation and simulation techniques have exposed circuit setup and memory management overhead as performance bottlenecks; however, there are often a relatively small number of active components (which can be determined by FET disabling). Therefore, this disclosure presents methods and systems to partition (prune) a circuit for simulation that occurs at an early stage before any resources are used to flatten and evaluate inactive circuit components. This is more efficient than pruning at the circuit level after flattening (accomplished by modeling at the device level), or pruning after the processing and pattern matching of sub-circuit definitions has been performed (in the case of large hierarchical circuits, for example). These methods and systems are complementary to all partitioning methods and can provide additional reduction in memory and CPU time. Therefore, the systems and methods herein produce a reduced circuit that has fewer elements and partitioning is performed before flattening. The conventional partitioning happens later in the process after flattening. While both reduce the circuit to the same small number of active elements, the systems and methods herein do so without incurring the unnecessary overhead associated with flattening a larger circuit.

More specifically, the disclosed partitioning process uses a “circuit description” cache to enable or disable certain circuit descriptions rather than enabling and disabling flattened circuit elements. Further, such methods and systems partition the circuit at the first opportunity after the description is complete. This reduces the circuitry required for flattening and processing device models, and reduces the time needed for circuit creation, simulation and deletion. This also reduces memory needed for each simulated circuit, and can operate based entirely on abstract circuit description. The methods and systems herein leverage the infrastructure for sub-circuit disabling, and can be implemented as minimum partitions with FET disabling in API based simulation, netlist-driven simulation, etc.

As mentioned above, the methods and systems herein partition the circuit at the first opportunity after its description is complete and before any flattening and lengthy evaluations are done on the circuit. To operate efficiently, this is accomplished by intercepting and caching function calls to the simulator at the top level and performing partitioning on an abstraction of the circuit.

When partitioning the circuit, the systems and methods herein can determine which portions are inactive or active by observing the disabling of the field effect transistors (FETs). In this process, the user provides a list of disabled FETs and output nodes to the simulator along with the netlist. For example, the user may only be interested in the voltage response of the simulation. Disabled FETs (DF) are those transistors in the netlist that the user is certain will remain OFF during simulation due to the particular choice of the circuit's input signals. Output nodes (ON) are those nodes that the user desires to be included in the reduced sub-circuit for the purpose of recording signal measurements. Provided with such ON and DF lists, the circuit simulator is modified to identify a subset of the original circuit that guarantees to include the ON list and is smaller than the original circuit. Identifying the active sub-circuit can be accomplished by traversing the graph of the circuit, starting from output nodes, and by including circuit elements while excluding those FETs listed in DF set. One of the features of this is that the DF set does not need to include all the FETs that will be in the inactive sub-circuit. The DF list only needs to include those FETs that are at the boundary of active and inactive sub-circuits.

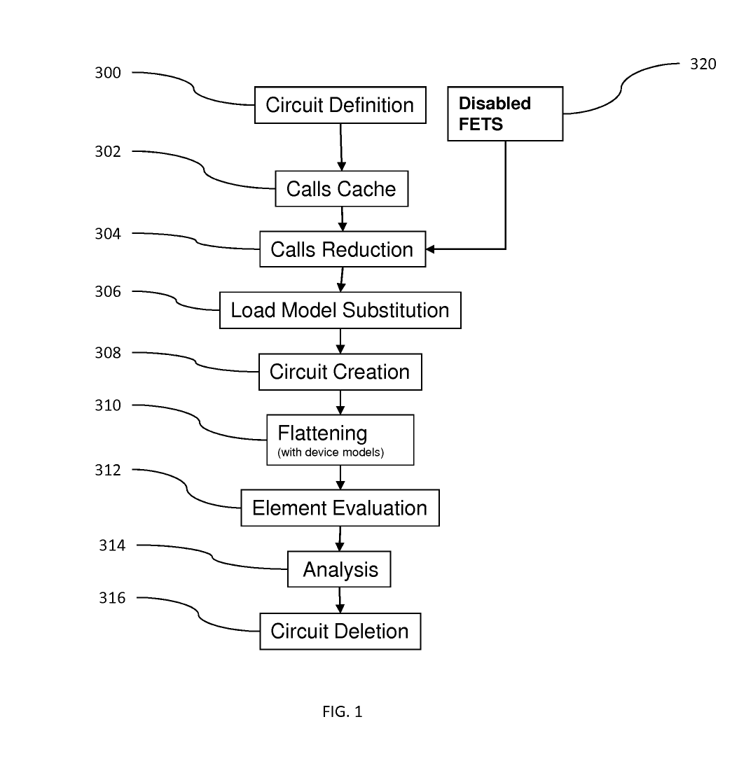

An exemplary method herein is shown in flowchart form in FIG. 1. This exemplary method receives a series of instructions directed to a circuit simulator (such as API calls or netlist parsing calls that make up a “circuit definition”) into a computerized device in item 300. The circuit simulator uses the series of instructions to create a simulation of an integrated circuit. The series of instructions can include circuit element description, electrical connections, and node identifications, etc.

However, before supplying the series of instructions to the circuit simulator, the methods and systems herein cache the series of instructions (caches the calls) in a cache memory of the computerized device in item 302. Then, after the series of instructions have been cached (and before supplying the series of instructions to the circuit simulator) the methods and systems herein partition the series of instructions into instructions directed to an active portion of the integrated circuit and instructions directed to an inactive portion of the integrated circuit, using the computerized device to reduce the calls 304.

More specifically, in item 304, only the calls (instructions) directed to an active portion of the integrated circuit are supplied to the simulator to reduce the processing time and memory requirements of the simulation. The partitioning process in item 304 occurs after all the series of instructions have been cached in item 302 and the partitioning can be, for example, based on a previously determined combination of enabled and disabled transistors (as represented by the previously created ON and DF list of disabled FETs discussed above in item 320) that indicate what parts of the simulated circuit would be active and which would be inactive.

Then, instead of supplying the entire series of instructions to the circuit simulator, the methods and systems herein load only the instructions directed to the active portion of the integrated circuit (load a substitution of the original calls) to the circuit simulator in item 306, using the computerized device. Thus, the circuit simulator creates a simulation of a reduced circuit from just the instructions directed to the active portion of the integrated circuit (instead of a full integrated circuit that would have been simulated with the entire series of instructions) in item 308. The circuit simulator can perform, for example, an application program interface (API) based simulation and a netlist-driven simulation, etc.

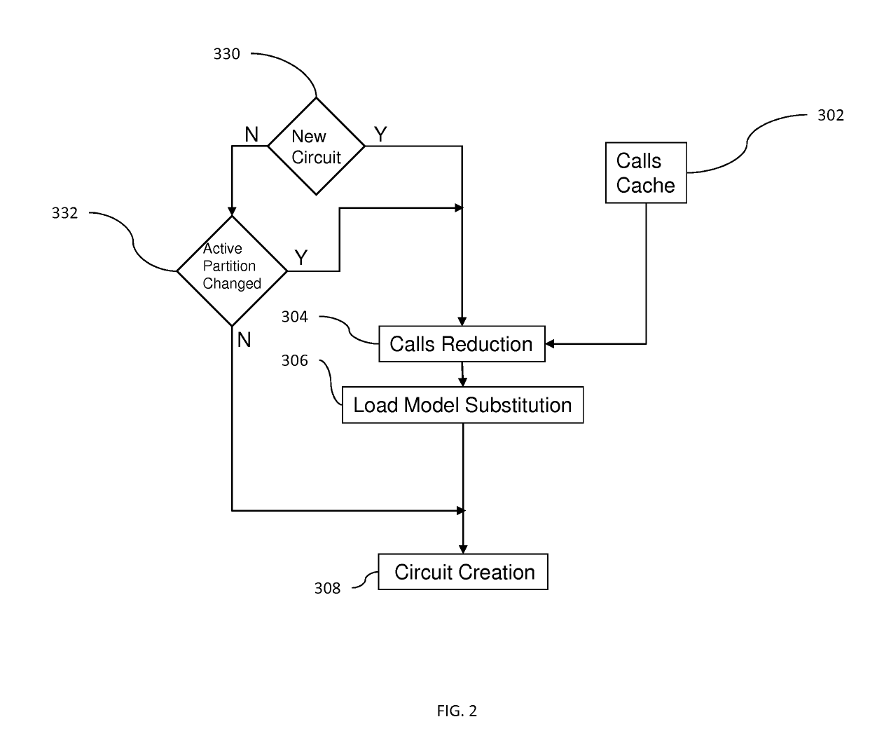

Further, as shown in FIG. 2, a determination can be made as to whether a new circuit 330 is present before the call reduction process 304 is performed. If a new circuit is not present, the calls will be reduced in item 304 only if the active partition 332 has been changed. Otherwise, processing can be directed to the simulator for circuit creation.

The reduced circuit simulated by these systems and methods has less circuit elements relative to any integrated circuit that would have been simulated with the entire series of instructions. Thus, this reduced circuit is only a portion of (the active portion) and is less than all of the integrated circuit that would have been simulated with the entire series of instructions.

Thus, when the reduced circuit is processed through device modeling (flattening in item 310), element evaluation 312, various analysis 314 (such as DC/transient analysis), to circuit deletion in item 316, the CPU processing and memory requirement overhead is substantially reduced when compared to a full integrated circuit that would have been simulated with the entire series of instructions. As mentioned above, the systems and methods herein produce a reduced circuit that has fewer elements and partitioning is performed before flattening. The conventional partitioning happens later in the process after flattening. While both reduce the circuit to the same small number of active elements, the systems and methods herein do so without incurring the unnecessary overhead associated with flattening a larger circuit.

As will be appreciated by one skilled in the art, aspects of the systems and methods herein may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments herein. It will be understood that each block of the flowchart illustrations and/or two-dimensional block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

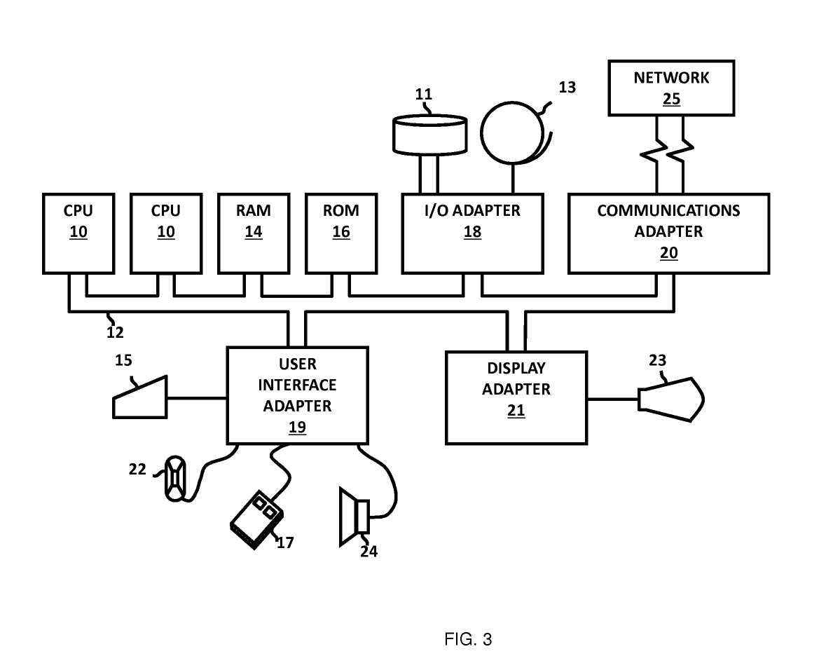

A representative hardware environment for practicing the embodiments herein is depicted in FIG. 3. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments herein. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The method as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

Deployment Types include loading directly in the client, server and proxy computers via loading a storage medium such as a CD, DVD, etc. The process software may also be automatically or semi-automatically deployed into a computer system by sending the process software to a central server or a group of central servers. The process software is then downloaded into the client computers that will execute the process software. The process software is sent directly to the client system via e-mail. The process software is then either detached to a directory or loaded into a directory by a button on the e-mail that executes a program that detaches the process software into a directory. Send the process software directly to a directory on the client computer hard drive. When there are proxy servers, the process will, select the proxy server code, determine on which computers to place the proxy servers' code, transmit the proxy server code, and then install the proxy server code on the proxy computer. The process software will be transmitted to the proxy server then stored on the proxy server.

While it is understood that the process software may be deployed by manually loading directly in the client, server and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively the process software is sent directly to the client system via e-mail. The process software is then either detached to a directory or loaded into a directory by a button on the e-mail that executes a program that detaches the process software into a directory. Another alternative is to send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

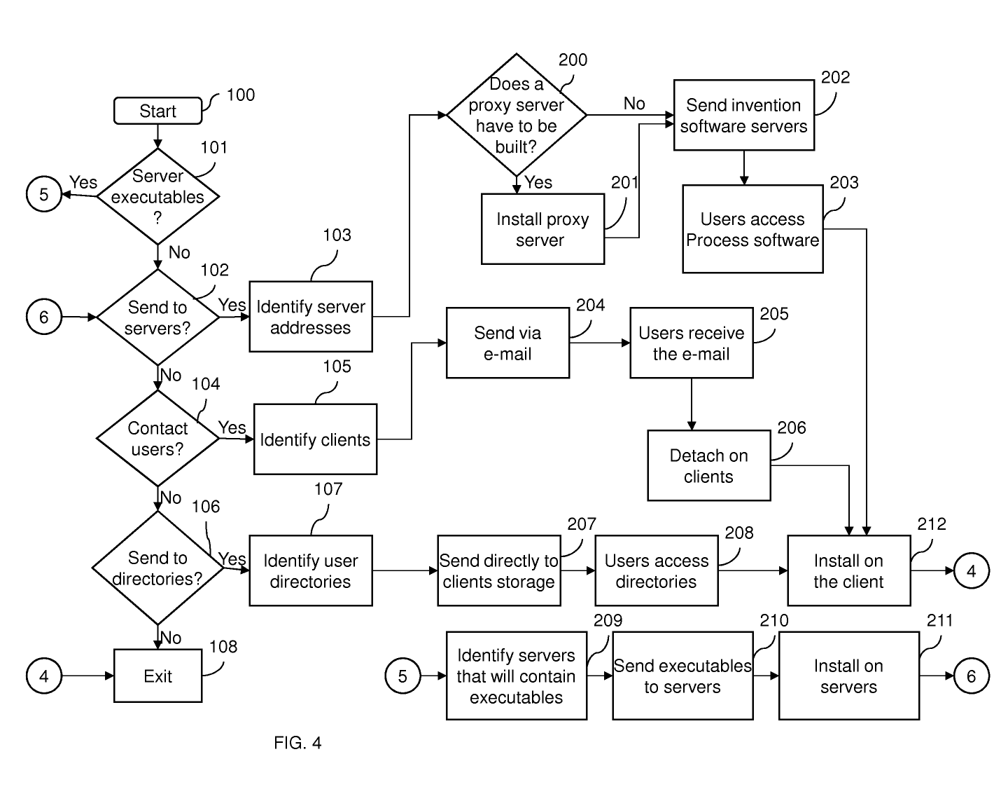

In FIG. 4, Step 100 begins the deployment of the process software. The first thing is to determine if there are any programs that will reside on a server or servers when the process software is executed 101. If this is the case then the servers that will contain the executables are identified 209. The process software for the server or servers is transferred directly to the servers' storage via FTP or some other protocol or by copying though the use of a shared file system 210. The process software is then installed on the servers 211.

Next, a determination is made on whether the process software is be deployed by having users access the process software on a server or servers 102. If the users are to access the process software on servers then the server addresses that will store the process software are identified 103.

A determination is made if a proxy server is to be built 200 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed 201. The process software is sent to the servers either via a protocol such as FTP or it is copied directly from the source files to the server files via file sharing 202. Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems 203. Another embodiment is to have the servers automatically copy the process software to each client and then run the installation program for the process software at each client computer. The user executes the program that installs the process software on his client computer 212 then exits the process 108.

In step 104 a determination is made whether the process software is to be deployed by sending the process software to users via e-mail. The set of users where the process software will be deployed are identified together with the addresses of the user client computers 105. The process software is sent via e-mail to each of the users' client computers. The users then receive the e-mail 205 and then detach the process software from the e-mail to a directory on their client computers 206. The user executes the program that installs the process software on his client computer 212 then exits the process 108.

Lastly a determination is made on whether to the process software will be sent directly to user directories on their client computers 106. If so, the user directories are identified 107. The process software is transferred directly to the user's client computer directory 207. This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software 208. The user executes the program that installs the process software on his client computer 212 then exits the process 108.

The process software is integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

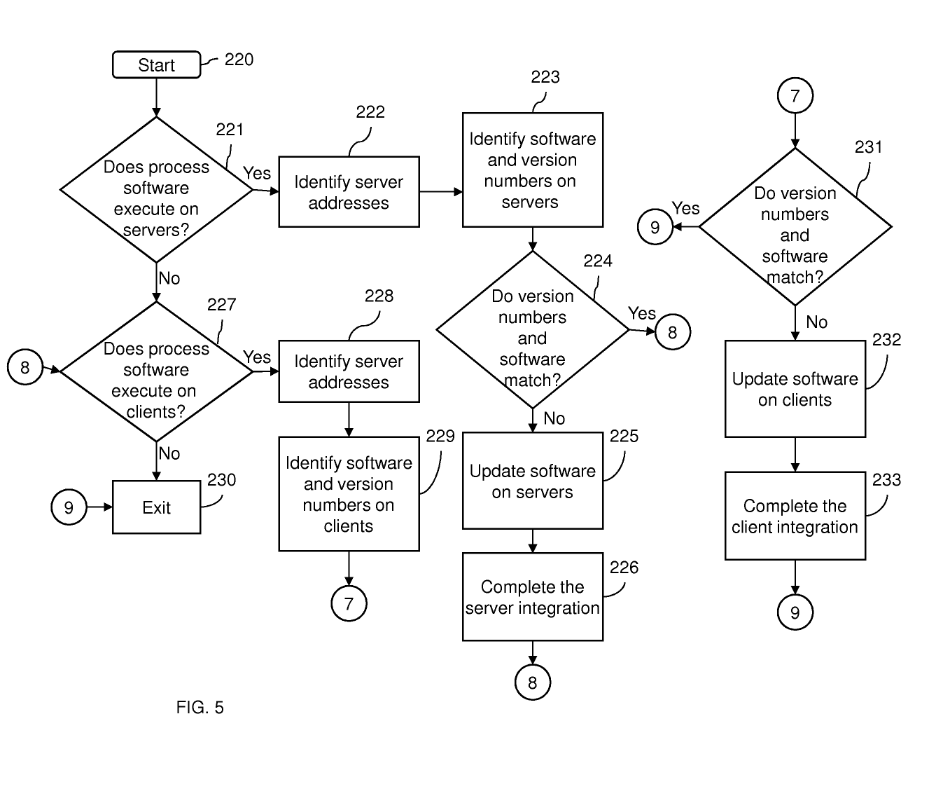

In FIG. 5, Step 220 begins the integration of the process software. The first thing is to determine if there are any process software programs that will execute on a server or servers 221. If this is not the case, then integration proceeds to 227. If this is the case, then the server addresses are identified 222. The servers are checked to see if they contain software that includes the operating system (OS), applications, and network operating systems (NOS), together with their version numbers, that have been tested with the process software 223. The servers are also checked to determine if there is any missing software that is required by the process software 223.

A determination is made if the version numbers match the version numbers of OS, applications and NOS that have been tested with the process software 224. If all of the versions match and there is no missing required software the integration continues in 227.

If one or more of the version numbers do not match, then the unmatched versions are updated on the server or servers with the correct versions 225. Additionally if there is missing required software, then it is updated on the server or servers 225. The server integration is completed by installing the process software 226.

Step 227 which follows either 221, 224 or 226 determines if there are any programs of the process software that will execute on the clients. If no process software programs execute on the clients the integration proceeds to 230 and exits. If this not the case, then the client addresses are identified 228.

The clients are checked to see if they contain software that includes the operating system (OS), applications, and network operating systems (NOS), together with their version numbers, that have been tested with the process software 229. The clients are also checked to determine if there is any missing software that is required by the process software 229.

A determination is made as to whether the version numbers match the version numbers of OS, applications and NOS that have been tested with the process software 231. If all of the versions match and there is no missing required software, then the integration proceeds to 230 and exits.

If one or more of the version numbers do not match, then the unmatched versions are updated on the clients with the correct versions 232. In addition, if there is missing required software then it is updated on the clients 232. The client integration is completed by installing the process software on the clients 233. The integration proceeds to 230 and exits.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc. When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to effect the performance of that server, other servers are accessed to increase the capacity and to share the workload. Likewise when other measurements of use such as network bandwidth, memory usage, storage usage, etc. approach a capacity so as to effect performance, additional network bandwidth, memory usage, storage etc. are added to share the workload. The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider. In another embodiment, the service provider requests payment directly from a customer account at a banking or financial institution. In another embodiment, if the service provider is also a customer of the customer that uses the process software application, the payment owed to the service provider is reconciled to the payment owed by the service provider to minimize the transfer of payments.

The process software is shared, simultaneously serving multiple customers in a flexible, automated fashion. It is standardized, requiring little customization and it is scalable, providing capacity on demand in a payas-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to effect the performance of that server, other servers are accessed to increase the capacity and to share the workload. Likewise when other measurements of use such as network bandwidth, memory usage, storage usage, etc. approach a capacity so as to effect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

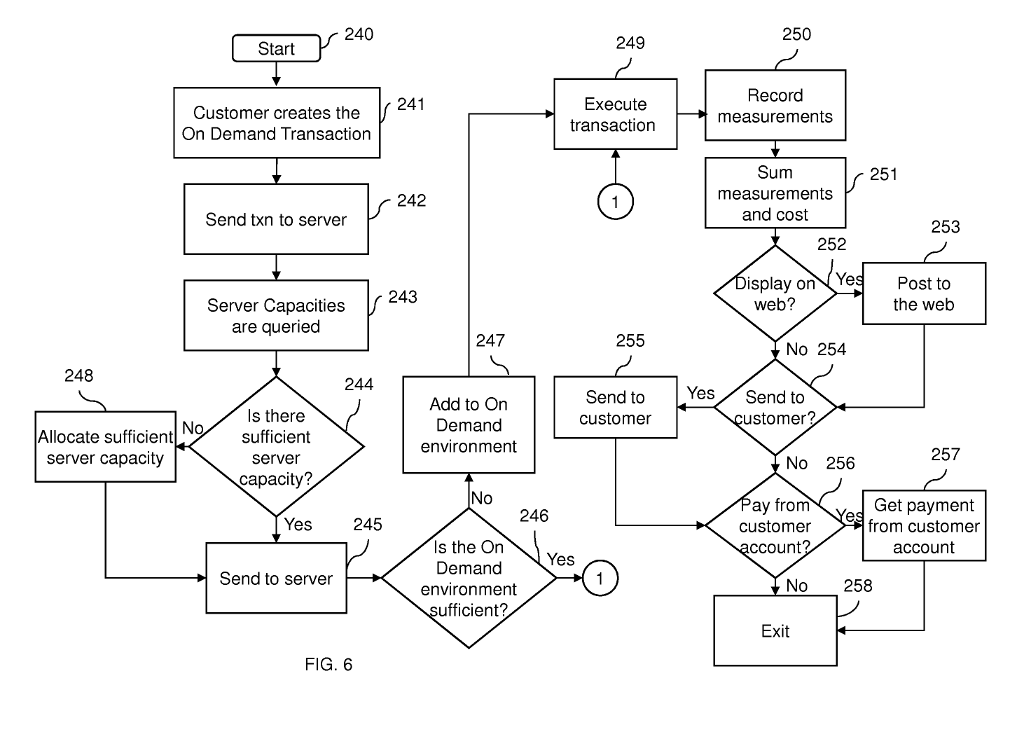

In FIG. 6, Step 240 begins the On Demand process. A transaction is created than contains the unique customer identification, the requested service type and any service parameters that further specify the type of service 241. The transaction is then sent to the main server 242. In an On Demand environment the main server can initially be the only server, then as capacity is consumed other servers are added to the On Demand environment.

The server central processing unit (CPU) capacities in the On Demand environment are queried 243. The CPU requirement of the transaction is estimated, then the servers available CPU capacity in the On Demand environment are compared to the transaction CPU requirement to see if there is sufficient CPU available capacity in any server to process the transaction 244. If there is not sufficient server CPU available capacity, then additional server CPU capacity is allocated to process the transaction 248. If there was already sufficient Available CPU capacity then the transaction is sent to a selected server 245.

Before executing the transaction, a check is made of the remaining On Demand environment to determine if the environment has sufficient available capacity for processing the transaction. This environment capacity consists of such things as but not limited to network bandwidth, processor memory, storage etc. 246. If there is not sufficient available capacity, then capacity will be added to the On Demand environment 247. Next the required software to process the transaction is accessed, loaded into memory, then the transaction is executed 249.

The usage measurements are recorded 250. The usage measurements consists of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer 251. If the customer has requested that the On Demand costs be posted to a web site 252 then they are posted 253.

If the customer has requested that the On Demand costs be sent via e-mail to a customer address 254 then they are sent 255. If the customer has requested that the On Demand costs be paid directly from a customer account 256 then payment is received directly from the customer account 257. The last step is exit the On Demand process.

The process software may be deployed, accessed and executed through the use of a virtual private network (VPN), which is any combination of technologies that can be used to secure a connection through an otherwise unsecured or untrusted network. The use of VPNs is to improve security and for reduced operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process the of placing an entire packet within another packet and sending it over a network. The protocol of the outer packet is understood by the network and both points, called tunnel interfaces, where the packet enters and exits the network.

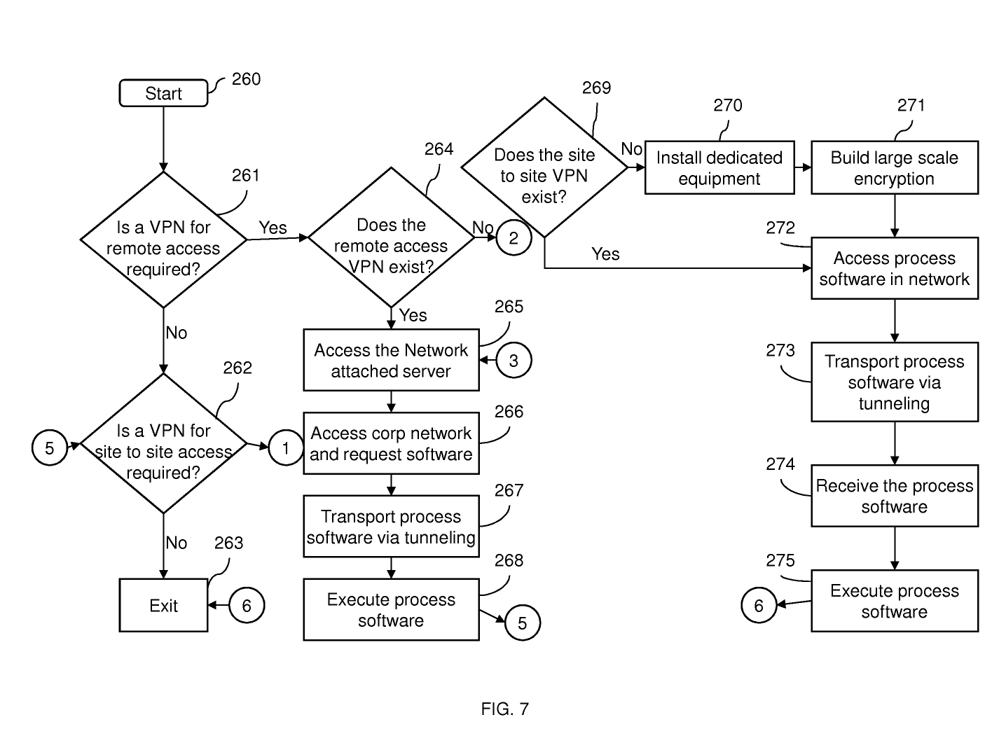

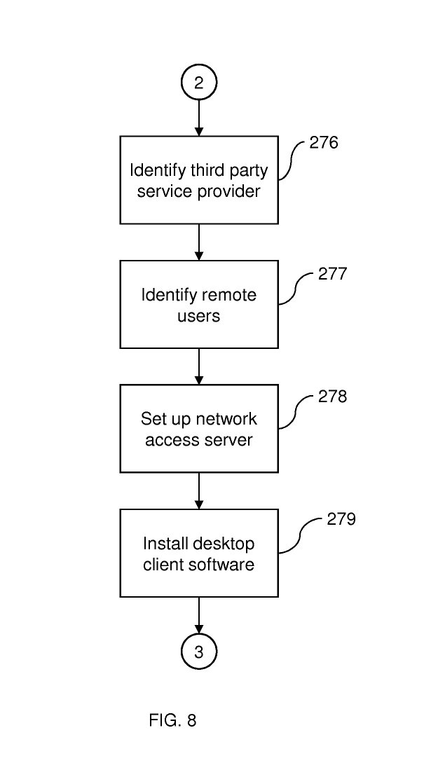

In FIGS. 7 and 8, Step 260 begins the Virtual Private Network (VPN) process. A determination is made to see if a VPN for remote access is required 261. If it is not required, then proceed to 262. If it is required, then determine if the remote access VPN exists 264.

If it does exist, then proceed to 265. Otherwise identify the third party provider that will provide the secure, encrypted connections between the company's private network and the company's remote users 276. The company's remote users are identified 277. The third party provider then sets up a network access server (NAS) 278 that allows the remote users to dial a toll free number or attach directly via a cable or DSL modem to access, download and install the desktop client software for the remote-access VPN 279.

After the remote access VPN has been built or if it been previously installed, the remote users can then access the process software by dialing into the NAS or attaching directly via a cable or DSL modem into the NAS 265. This allows entry into the corporate network where the process software is accessed 266. The process software is transported to the remote user's desktop over the network via tunneling. That is the process software is divided into packets and each packet including the data and protocol is placed within another packet 267. When the process software arrives at the remote user's desktop, it is removed from the packets, reconstituted and then is executed on the remote users desktop 268.

A determination is made to see if a VPN for site to site access is required 262. If it is not required, then proceed to exit the process 263. Otherwise, determine if the site to site VPN exists 269. If it does exist, then proceed to 272. Otherwise, install the dedicated equipment required to establish a site to site VPN 270. Then build the large scale encryption into the VPN 271.

After the site to site VPN has been built or if it had been previously established, the users access the process software via the VPN 272. The process software is transported to the site users over the network via tunneling. That is the process software is divided into packets and each packet including the data and protocol is placed within another packet 274. When the process software arrives at the remote user's desktop, it is removed from the packets, reconstituted and is executed on the site users desktop 275. Proceed to exit the process 263.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving a series of instructions directed to a circuit simulator into a computerized device, said circuit simulator using said series of instructions to create a simulation of an integrated circuit;
before supplying said series of instructions to said circuit simulator, partitioning said series of instructions into instructions directed to an active portion of said integrated circuit and instructions directed to an inactive portion of said integrated circuit, using said computerized device; and
supplying only said instructions directed to said active portion of said integrated circuit to said circuit simulator, using said computerized device,
said circuit simulator creating a simulation of a reduced circuit from said instructions directed to said active portion of said integrated circuit, said reduced circuit having less circuit elements relative to said integrated circuit.

2. The method according to claim 1, said reduced circuit comprising a portion of and being less than all of said integrated circuit.

3. The method according to claim 1, said series of instructions comprising circuit element description, electrical connections, and node identifications.

4. The method according to claim 1, said series of instructions comprising one of application program interface (API) calls and netlist parsing calls.

5. The method according to claim 1, said circuit simulator comprising one of an application program interface (API) based simulation and a netlist-driven simulation.

6. The method according to claim 1, said partitioning occurring after all said series of instructions have been cached.

7. The method according to claim 1, said partitioning being based on a previously determined combination of enabled and disabled transistors.

8. A method comprising:
receiving a series of instructions directed to a circuit simulator into a computerized device, said circuit simulator using said series of instructions to create a simulation of an integrated circuit;
before supplying said series of instructions to said circuit simulator, cashing said series of instructions in a cache memory of said computerized device;
after said series of instructions have been cached and before supplying said series of instructions to said circuit simulator, partitioning said series of instructions into instructions directed to an active portion of said integrated circuit and instructions directed to an inactive portion of said integrated circuit, using said computerized device; and
supplying only said instructions directed to said active portion of said integrated circuit to said circuit simulator, using said computerized device,
said circuit simulator creating a simulation of a reduced circuit from said instructions directed to said active portion of said integrated circuit, said reduced circuit having less circuit elements relative to said integrated circuit.

9. The method according to claim 8, said reduced circuit comprising a portion of and being less than all of said integrated circuit.

10. The method according to claim 8, said series of instructions comprising circuit element description, electrical connections, and node identifications.

11. The method according to claim 8, said series of instructions comprising one of application program interface (API) calls and netlist calls.

12. The method according to claim 8, said circuit simulator comprising one of an application program interface (API) based simulation and a netlist-driven simulation.

13. The method according to claim 8, said partitioning occurring after all said series of instructions have been cached.

14. The method according to claim 8, said partitioning being based on a previously determined combination of enabled and disabled transistors.

15. A tanbible computer-readable storage medium storing instructions executable by a computerized device, said instructions causing said computerized device to perform a method comprising:
receiving a series of instructions directed to a circuit simulator into said computerized device, said circuit simulator using said series of instructions to create a simulation of an integrated circuit;
before supplying said series of instructions to said circuit simulator, partitioning said series of instructions into instructions directed to an active portion of said integrated circuit and instructions directed to an inactive portion of said integrated circuit, using said computerized device; and
supplying only said instructions directed to said active portion of said integrated circuit to said circuit simulator, using said computerized device,
said circuit simulator creating a simulation of a reduced circuit from said instructions directed to said active portion of said integrated circuit, said reduced circuit having less circuit elements relative to said integrated circuit.

16. The tanbible computer-readable storage medium according to claim 15, said reduced circuit comprising a portion of and being less than all of said integrated circuit.

17. The tanbible computer-readable storage medium according to claim 15, said series of instructions comprising circuit element description, electrical connections, and node identifications.

18. The tanbible computer-readable storage medium according to claim 15, said series of instructions comprising one of application program interface (API) calls and netlist parsing calls.

19. The tanbible computer-readable storage medium according to claim 15, said circuit simulator comprising one of an application program interface (API) based simulation and a netlist-driven simulation.

20. The tanbible computer-readable storage medium according to claim 15, said partitioning being based on a previously determined combination of enabled and disabled transistors.
